(19) United States
(12) Patent Application Publication
(10) Pub. No.: US 2026/0263298 A1
(43) Pub. Date: Sep. 10, 2026

(54) WEIGHTED SURFACE FOR IMPROVED FRAME CONFORMANCE

(71) Applicant: Hill-Rom Services, Inc., Batesville, IN (US)

(72) Inventors: Jnanesha RAMEGOWDA, Batesville, IN (US); Douglas E. BORGMAN, Brookville, IN (US); Darrell L. BORGMAN, Batesville, IN (US); Kathryn Ruth SMITH, Batesville, IN (US)

(21) Appl. No.: 19/559,731

(22) Filed: Mar. 6, 2026

Related U.S. Application Data
(60) Provisional application No. 63/769,453, filed on Mar. 10, 2025.

(51) Int. Cl. A61G 7/005; A61G 7/015; A61G 7/018

(52) U.S. Cl. CPC A61G 7/005; A61G 7/015; A61G 7/018; A61G 2210/50

(57) ABSTRACT

A modular patient support apparatus includes mechanisms which provide advanced kinematics for moving portions of the patient support apparatus. The patient support apparatus includes a mattress with one or more weights so that the mattress can conform to a patient support deck of the patient support apparatus in the absence of patient weight.

### PRIORITY CLAIM

This application claims priority under 35 U.S.C. § 119(e) to U.S. Provisional Application No. 63/769,453, filed Mar. 10, 2025, which is expressly incorporated by reference herein.

### BACKGROUND

The present disclosure is related to a modular patient support apparatus that is adaptable to provide support to a patient with minimal caregiver help. More specifically, the present disclosure is related to a patient support apparatus with a mattress that is adaptable to different articulations of the patient support apparatus.

In the modern healthcare facility, patients are often kept for extended periods in the emergency unit or in an observation ward on patient support apparatus while tests are run and the patient is under observation. Patient support apparatus (i.e., beds and stretchers) typically have manual articulation controls that require pulling one of two or more handles to release a locked component so that a portion of the patient support apparatus's frame can be articulated. For example, pulling a handle on the top corner of the stretcher's head section may release the head section's locking gas spring so that the head section could be raised or lowered. In some instances, the patient may be in significant discomfort, lack mobility, or be otherwise incapacitated. Support mattresses are positioned on patient support apparatus and are configured to provide support and comfort to the patient. These support mattresses typically conform to the base of the patient support apparatus when the patient is using them. However, these support mattresses may separate from the patient support apparatus that have been articulated to different positions when a patient moves due to the lack of any weight on them.

There are various methods used currently to conform a mattress to the frame of the patient support apparatus. These include attachment aids such as knobs in a slot, straps, ties, buckles, and/or hooks. Grippy materials such as Velcro may be used to prevent surface motion, but such materials may not ensure conformance to articulations. Further, materials like Velcro can accumulate dirt and bacteria, thereby impacting patient care. Therefore, there is a need for improved systems and methods to conform the mattress to the frame of the patient support apparatus. The disclosure is directed to systems and methods for efficiently conforming a mattress to the frame of the patient support apparatus.

### SUMMARY

The present disclosure includes one or more of the features recited in the appended claims and/or the following features which, alone or in any combination, may comprise patentable subject matter.

According to a first aspect of the present disclosure, a patient support apparatus comprises a patient support apparatus, including a base frame, an upper frame movable in a vertical direction relative to the base frame, a patient support deck supported by the upper frame, the patient support deck comprising a calf deck section and a thigh deck section, the calf deck section and the thigh deck section being pivotable relative to one another to define an articulated position, a user control mechanism configured to pivot the calf deck section and the thigh deck section relative to one another and create the articulated position, and a mattress supported by the patient support deck and configured to bend at a pivot point of the calf deck section and the thigh deck section when the user control mechanism is configured to pivot the calf deck section and the thigh deck section to create the articulated position. The mattress comprises a cushioning layer and at least one weight, the at least one weight located in or adjacent to the cushioning layer, wherein the at least one weight is configured to maintain substantially full contact between the mattress and the patient support deck when the calf deck section and the thigh deck section are in the articulated position.

In some embodiments of the first aspect, the at least one weight may be at least about 2 lbs to about 25 lbs. In some embodiments of the first aspect, the at least one weight may comprise at least one of sand, metal, plastic, rubber, and gel.

In some embodiments of the first aspect, the cushioning layer may comprise an upper cushioning layer and a lower cushioning layer and the at least one weight is located between the upper cushioning layer and the lower cushioning layer.

In some embodiments of the first aspect, the cushioning layer may comprise foam. In some embodiments of the first aspect, the mattress may comprise a plurality of weights. In some embodiments of the first aspect, wherein the at least one weight may be positioned at a foot end of the mattress.

In some embodiments of the first aspect, the at least one weight may comprise a plurality of layers. In some embodiments of the first aspect, each of the plurality of layers may comprise a different material. In some embodiments of the first aspect, the at least one weight may comprise a radiolucent material.

In some embodiments of the first aspect, the calf deck section and the thigh deck section may be at an angle of about 20 degrees to about 60 degrees relative to each other when the patient support deck is in the articulated position.

According to a second aspect of the present disclosure, a mattress, comprises a cushioning layer including an upper cushioning layer and a lower cushioning layer and at least one weight positioned at a foot end of the mattress between the upper cushioning layer and the lower cushioning layer. The at least one weight is configured to maintain substantially full contact between the mattress and a support deck of a patient support apparatus when the support deck is in an articulated position, wherein the articulated position is defined by a first section of the support deck being pivotable relative to a second section of the support deck.

In some embodiments of the second aspect, the support deck is supported by an upper frame of the patient support apparatus. In some embodiments of the second aspect, the first section and the second section are configured to be pivotable relative to one by a user control mechanism located on the patient support apparatus.

In some embodiments of the second aspect, the at least one weight may be at least about 2 lbs to about 25 lbs. In some embodiments of the second aspect, the at least one weight may comprise at least one of sand, metal, plastic, rubber, and gel. In some embodiments of the second aspect, the cushioning layer may comprise foam.

In some embodiments of the second aspect, the mattress may comprise a plurality of weights. In some embodiments of the second aspect, the at least one weight may comprise a plurality of layers.

In some embodiments of the second aspect, each of the plurality of layers may comprise a different material. In some embodiments of the second aspect, the at least one weight may comprise a radiolucent material.

In some embodiments of the second aspect, the first section and the second section may be at an angle of about 20 degrees to about 60 degrees relative to each other when the support deck is in the articulated position. In some embodiments of the second aspect, the first section of the support deck may be a calf deck section, and the second section of the support deck may be a thigh deck section. In some embodiments of the second aspect, the first section of the support deck may be a head deck section, and the second section of the support deck may be a back deck section.

According to a third aspect of the present disclosure, a method of operating a patient support apparatus, comprises pivoting a first section of a support deck relative to a second section of a patient support deck to define an articulated position, and maintaining substantially full contact between a mattress positioned on the patient support deck and the support deck when the first section and the second section are in the articulated position. The mattress comprises a cushioning layer and at least one weight located in or adjacent to the cushioning layer.

In some embodiments of the third aspect, the support deck is supported by an upper frame of the patient support apparatus. In some embodiments of the third aspect, the first section and the second section are configured to be pivotable relative to one by a user control mechanism located on the patient support apparatus.

In some embodiments of the third aspect, the at least one weight may be at least about 2 lbs to about 25 lbs. In some embodiments of the third aspect, the at least one weight may comprise at least one of sand, metal, plastic, rubber, and gel. In some embodiments of the third aspect, the cushioning layer may comprise foam.

In some embodiments of the third aspect, the mattress may comprise a plurality of weights. In some embodiments of the third aspect, the at least one weight may comprise a plurality of layers. In some embodiments of the third aspect, each of the plurality of layers may comprise a different material.

In some embodiments of the third aspect, the at least one weight may comprise a radiolucent material. In some embodiments of the third aspect, the first section and the second section may be at an angle of about 20 degrees to about 60 degrees relative to each other when the support deck is in the articulated position. In some embodiments of the third aspect, the first section of the support deck may be a calf deck section, and the second section of the support deck may be a thigh deck section. In some embodiments of the third aspect, the first section of the support deck may be a head deck section, and the second section of the support deck may be a back deck section.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a first embodiment of a patient support apparatus according to the present disclosure;

FIG. 2 is an illustration of a mattress that is positioned on a patient support deck configured to be in an articulated position;

FIG. 3 is an illustration of a mattress with an embedded weight that is positioned on a patient support deck configured to be in an articulated position;

FIG. 4 is an illustration of a mattress with two cushioning layers and an embedded weight located between the cushioning layers that is positioned on a patient support deck configured to be in an articulated position;

FIG. 5 is an illustration of a mattress with a plurality of embedded weights that is positioned on a patient support deck configured to be in an articulated position;

FIG. 6 is an illustration of a mattress with an embedded weight comprising two layers positioned on a patient support deck configured to be in an articulated position; and

FIG. 7 is an illustration of a mattress with a plurality of embedded weights separated by a protective layer that is positioned on a patient support deck configured to be in an articulated position.

### DETAILED DESCRIPTION

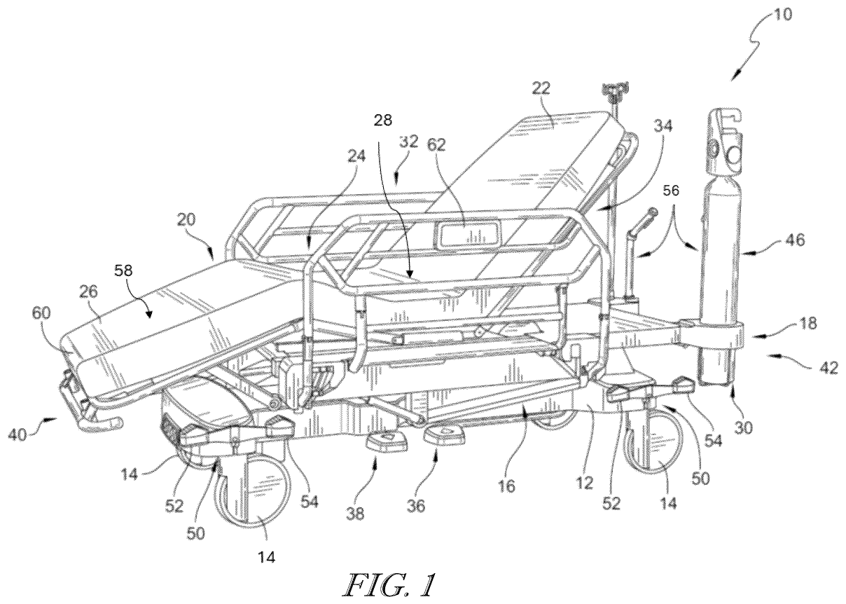

According to the present disclosure, a patient support apparatus 10 shown in FIG. 1 is configurable to provide care to patients of varying acuity, while also providing improved mobility as a patient is moved between areas of a care facility, such as a hospital. The patient support apparatus 10 includes a base 12 supported on four casters 14 which are lockable to prevent movement of the patient support apparatus 10 over the floor but are oversized to provide smooth movement over the floor when released. The base 12 supports a lift assembly 16 which provides cantilevered support of an upper frame 18 and moves the upper frame 18 vertically when the lift assembly 16 is activated.

The upper frame 18 supports a patient support deck 20. The patient support deck 20 has multiple sections and panels. The panels may be constructed of a radiolucent material so that a C-arm x-ray device or other similar imaging devices may be used with the patient support deck 20. The patient support deck 20 has a pivoting head deck section 22 that pivots or moves relative to the upper frame 18 and a back deck section 28. A thigh deck section 24 is also pivotable relative to the upper frame 18. A calf deck section 26 is supported from the upper frame 18 and pivotable relative to the thigh deck section 24. The calf deck section 26 is configurable to move to a dependent position wherein a foot end 40 of the calf deck section 26 drops below the upper frame 18 so that the patient support deck 20 may form a chair-like arrangement for patient comfort and optimal positioning. In the embodiment of FIG. 1, the articulation of the calf deck section 26 and thigh deck section 24 of the patient support apparatus 10 is accomplished manually. The same is true of the head deck section 22. The articulation may be assisted by a releasable gas spring, which provides some force to assist in the movement of the sections when they are being manually manipulated. In some embodiments, the articulation may be assisted by an electric actuator.

To assist with the mobility of the patient support apparatus 10, push handles 56 are positioned at a head end 42 of the patient support apparatus 10. The push handles 56 in the embodiment of FIG. 1 are fixed to the upper frame 18 and the height of the push handles 56 is adjusted by adjusting the height of the upper frame 18 using the lift assembly 16. The patient support apparatus 10 also includes an oxygen tank holder 30 that supports an oxygen tank 46. The patient support apparatus 10 further includes a right-side rail 32 and a left-side rail 34. The orientation of the sides and ends of the patient support apparatus 10 is established by the orientation of a patient supported on the patient support apparatus 10 in a supine position such that the right-side rail 32 is positioned to the patient's right and the left-side rail 34 is positioned to the patient's left. Similarly, references to calf deck section 26 or foot end 40 related to the position of the patient's feet when in the supine position on the patient support apparatus 10. Likewise, the head end 42 is oriented at the end of the patient support apparatus 10 where a patient's head would be in a supine position.

The lift assembly 16 is operated by a raise pedal 36 that may allow a user to manually activate the raise pedal 36 so that the lift assembly 16 is raised. In some embodiments, the raise pedal 36 may require multiple activations to move the lift assembly 16, but in other embodiments, the lift assembly 16 may be powered to actuate with a single activation of the raise pedal 36. A lower pedal 38 is actuable to cause the lift assembly 16 to lower, thereby lowering the upper frame 18.

The patient support apparatus 10 includes a brake/steer mechanism supported by the base 12. The brake/steer mechanism is of the type known in the art and able to transition the operation of the casters 14 between a full lock that prevents rotation of the wheels of the caster 14 and prevents swiveling of the caster 14 about a vertical axis, a neutral position in which the casters 14 are free to rotate and swivel, and a steer position in which at least one of the casters 14 is locked in swivel to serve as a tracking wheel to assist with steering of the patient support apparatus 10. In the present embodiment, the caster 14 positioned at the left foot end 40 of the patient support apparatus 10 serves as the steer caster. In other embodiments, a different caster 14 may be placed in steer. The activation of the brake/steer mechanism is provided by an actuator 50 which is positioned at each caster 14, each actuator 50 having a brake pedal 52 and a steer pedal 54 as is known in the art. This allows a caregiver to actuate the brake/steer mechanism at multiple positions about the periphery of the patient support apparatus 10.

Notably, the patient support apparatus 10 further includes a support cushion assembly or mattress 60 supported on the patient support deck 20 and movable with the patient support deck 20 to conform to the patient support deck 20 in multiple positions. Additionally, the patient support apparatus 10 includes a user interface 62 that is configured to operate a scale system built into the patient support apparatus 10 as is known in the art. The user interface 62 is also configurable to position the patient support deck 20 in different configurations as discussed below.

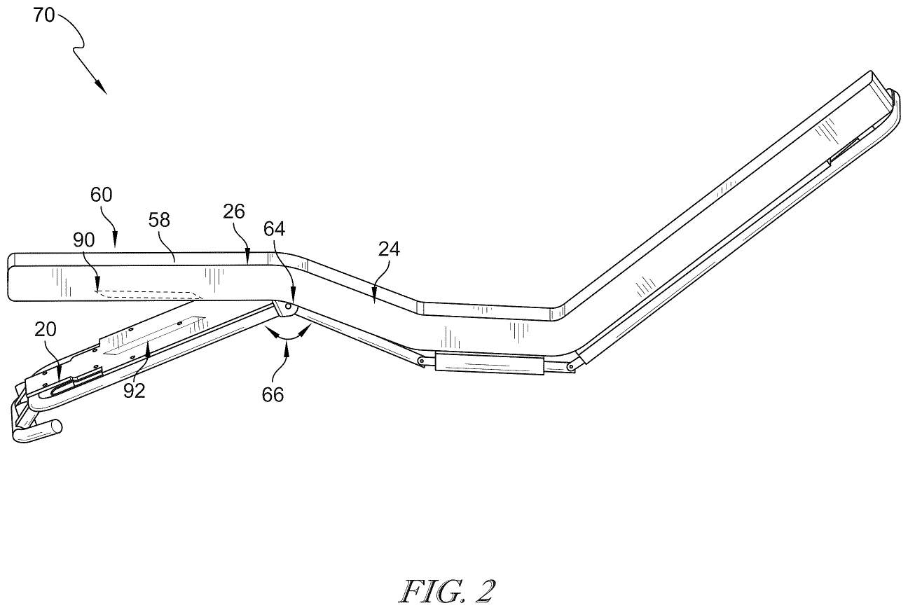

Referring now to FIG. 2, the kinematic functionality of the movement of the calf deck section 26 is shown with a lowered position compared to the thigh deck section 24. The calf deck section 26 is moved by a releasable actuator which is pinned to the upper frame 18 about a pivot point 64. The calf deck section 26 and the thigh deck section 24 are pivotable relative to one another at the pivot point 64 to define an articulated position 70 (i.e. a knee articulation) with an articulation angle 66 between the calf deck section 26 and the thigh deck section 24. The articulation angle 66 may be in the range of 20 degrees to about 160 degrees including any angle or range comprised therein. The user interface 62 can be used to position the patient support deck 20 in the articulated position 70 shown in FIG. 2. When the patient support deck 20 is positioned in the articulated position 70, the mattress 60 supported on the patient support deck 20 is configured to bend around at the pivot point 64.

Typically, the support cushion assembly or mattress 60 supported on the patient support deck 20 comprises materials that do not easily conform to articulation positions including but not limited to knee articulations and/or head of bed (HOB) elevations. In some embodiments, the support cushion assembly or mattress 60 supported on the patient support deck 20 comprises a cushioning layer 58 that includes materials such as foam or gel. Therefore, the mattress 60 cannot maintain substantial contact with the patient support deck 20 in the articulated position 70 when there is no patient resting on the mattress 60. As shown in FIG. 2, the mattress 60 substantially separates from the patient support deck 20.

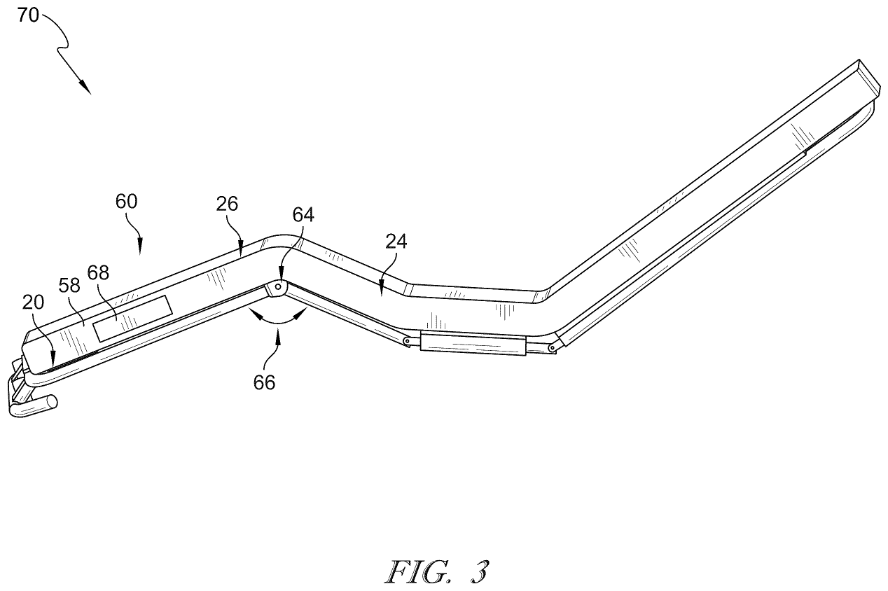

As shown in FIG. 3, selectively weighting sections of the mattress 60 allows the mattress 60 to conform to the patient support deck 20 without external intervention. For articulated positions 70 such as a knee articulation, a weight 68 embedded at the foot end 40 of the mattress 60 can ensure the mattress 60 conforms to the calf deck section 26 during knee articulation even if the patient's weight is not on the mattress 60. The weight 68 enables the mattress 60 to conform to the calf deck section 26 even when the articulation angle 66 is extreme and when other mechanisms such as Velcro patches or attachment aids such as knobs in a slot, straps, ties, buckles, and/or hooks would give way in the absence of patient weight. Further, the positioning of the weight 68 inside the mattress ensures that there is reduced risk of injury to the patient due to the weight 68 and a reduced risk of damage to the weight 68 due to any handling issues. Since the weight 68 is positioned inside the mattress 60, the weight 68 does not get dirty and does not have to be cleaned.

In some embodiments, the weight 68 may be used in combination with a Velcro patch 90 located on the underside of the mattress 60. In some embodiments, the weight 68 may be embedded at the foot end 40 of the mattress 60 to align with the Velcro patch 90 located on the underside of the mattress 60. As shown in FIG. 2, the Velcro patch 90 is configured to interface with a corresponding Velcro patch 92 located on the patient support deck 20 so as to attach the mattress 60 to the patient support deck 20. In some embodiments, the weight 68 may be used in combination with one or more attachment aids such as knobs in a slot, straps, ties, buckles, and/or hooks that are configured to attach the mattress 60 to the patient support deck 20. In some embodiments, the weight 68 may be used in combination with one or more attachment aids such as knobs in a slot, straps, ties, buckles, and/or hooks and one or more Velcro patches 90 to attach the mattress 60 to the patient support deck 20.

Additionally, incorporating the weight 68 inside the mattress 60 minimizes user interaction with the mattress 60 when ensuring that the mattress 60 remains in a position that conforms to the patient support deck 20 when the patient support deck 20 is in an articulated position. The weight 68 is only placed in selected locations in the mattress 60, and therefore, the overall weight of the mattress 60 is still low compared to using a weighted mattress that is uniformly heavy.

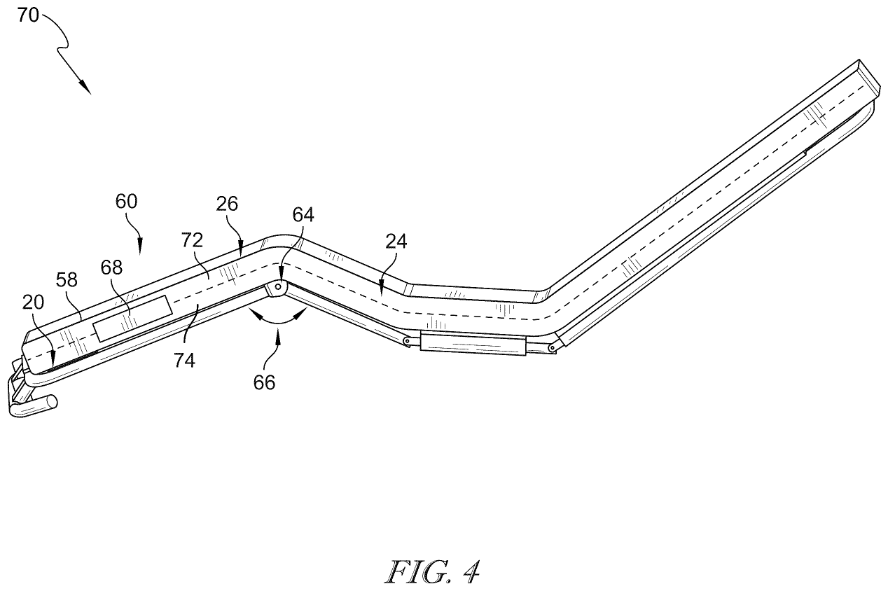

In some embodiments, as shown in FIG. 4, the cushioning layer 58 of the mattress 60 includes a first cushioning layer 72 and a second cushioning layer 74. The weight 68 is positioned between the first cushioning layer 72 and the second cushioning layer 74, thereby ensuring the weight 68 is surrounded by the cushioning layer 58 on all sides. The weight 68 illustrated in FIGS. 3 and 4 may comprise a higher density material such as a plate or sheet of metal, plastic, rubber, sand, or gel. The weight 68 may comprise of radiolucent materials. The weight 68 may weigh about 2 lbs to about 25 lbs, including any weight or range comprised therein. In some embodiments, the weight 68 may be placed in or adjacent to the cushioning layer 58.

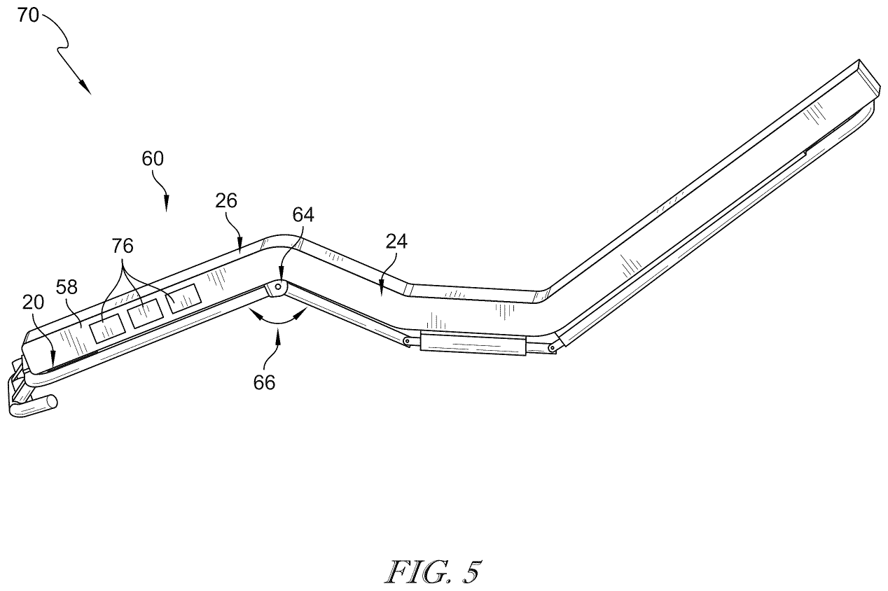

In some embodiments, as shown in FIG. 5, the mattress 60 may include a plurality of weights 76. The plurality of weights 76 may be arranged in different layouts and/or at different locations in the mattress 60. In some embodiments, the plurality of weights 76 may be arranged as a grid or sequentially in or adjacent to the cushioning layer 58 of the mattress 60. The plurality of weights 76 may be arranged to align with the calf deck section 26. The weights 76 may comprise a plurality of high-density materials so that the mattress 60 retains flexibility and compressibility. In some embodiments, the weights 76 may be positioned between the first cushioning layer 72 and the second cushioning layer 74, thereby ensuring the weight 68 is surrounded by the cushioning layer 58 on all sides. The weights 76 may comprise a higher density material such as a plate or a sheet of metal, plastic, rubber, sand. or gel. The weight 76 may comprise of a radiolucent material. Each of the weights 76 may weigh about 2 lbs to about 25 lbs, including any weight or range comprised therein.

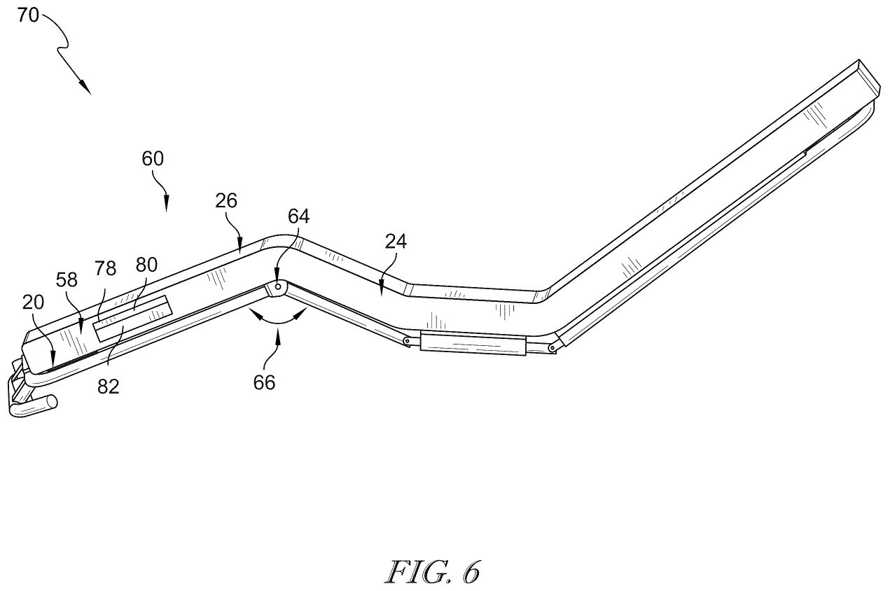

In some embodiments, as shown in FIG. 6, the mattress 60 may include a weight 78 that may comprise more than one weight layers 80, 82. Each weight layer 80, 82 may comprise a different material such as sand, metal, plastic, rubber, and/or gel. The weight 78 may include a first layer 80 and a second layer 82. Each weight layer 80, 82 may comprise a layering material such as sand, metal, plastic, rubber, and/or gel. Such layering materials can improve durability of the weight 78. The weight 78 may comprise a higher density material such as a plate or a sheet of metal, plastic, rubber, sand. or gel. The weight 78 may comprise of a radiolucent material. The weight 78 may weigh about 2 lbs to about 25 lbs, including any weight or range comprised therein.

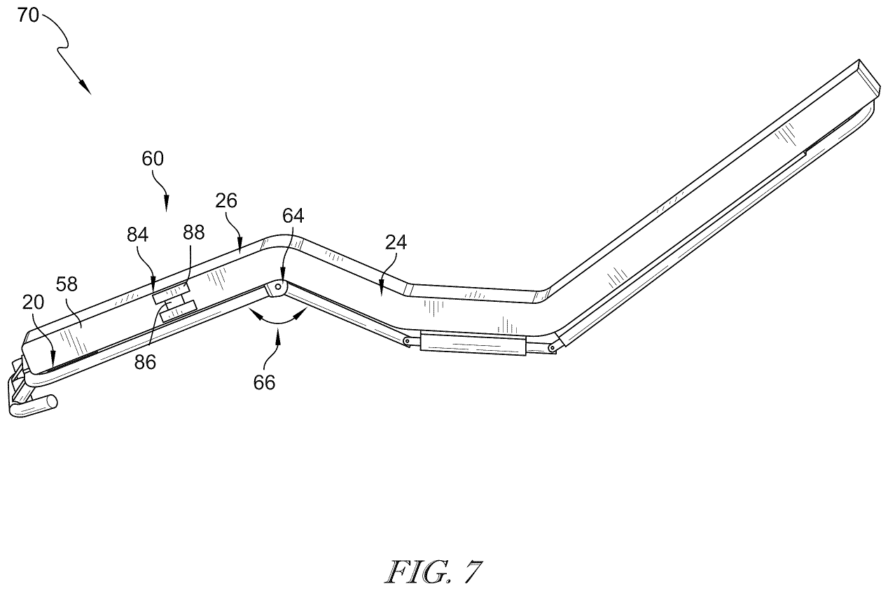

In some embodiments, as shown in FIG. 7, the mattress 60 may include a weight 84 two weight layers 88 attached to a protective layer 86 positioned between two weight layers 88. Each weight layer 88 and the protective layer 66 may comprise a different material such as sand, metal, plastic, rubber, and/or gel. The weight 84 may comprise a higher density material such as a plate or a sheet of metal, plastic, rubber, sand. or gel. The weight 84 may comprise of a radiolucent material. The weight 84 may weigh about 2 lbs to about 25 lbs, including any weight or range comprised therein.

In some embodiments, the weights 68, 76, 78, 84 may be positioned beneath the mattress 60. In some embodiments, the weights 68, 76, 78, 84 may be positioned on a surface cover of the mattress 60. For example, the weights 68, 76, 78, 84 may be positioned in pocket located on an upper surface or a lower surface of the mattress 60.

In some embodiments, the weights 68, 76, 78, 84 may be embedded in the mattress 60 that aligns with different components of the patient support deck 20. For example, the weights 68, 76, 78, 84 may be embedded in the mattress to align with one or more of the calf deck section 26, the back deck section 28, the thigh deck section 24, and/or head deck section 22. In some embodiments, more than one type of weights 68, 76, 78, 84 may be embedded in the same mattress 60. The weights 68, 76, 78, 84 may be configured to maintain substantially full contact between the mattress 60 positioned on the patient support deck 20 and the patient support deck 20 when one or more sections of the patient support deck 20 are in an articulated position. Substantially full contact may comprise about 60% to about 100% contact between the mattress 60 and the patient support deck 20, including any percentage or range comprised therein. Substantially full contact may comprise about 60% to about 70% contact, about 70% to about 80% contact, about 80% to about 90% contact, about 90% to about 100%, or about 95% to about 100% contact between the mattress 60 and the patient support deck 20.

Although this disclosure refers to specific embodiments, it will be understood by those skilled in the art that various changes in form and detail may be made without departing from the subject matter set forth in the accompanying claims. For example, the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

1. A patient support apparatus, comprising:
a base frame;
an upper frame movable in a vertical direction relative to the base frame;
a patient support deck supported by the upper frame, the patient support deck comprising a calf deck section and a thigh deck section, the calf deck section and the thigh deck section being pivotable relative to one another to define an articulated position;
a user control mechanism configured to pivot the calf deck section and the thigh deck section relative to one another and create the articulated position; and
a mattress supported by the patient support deck and configured to bend at a pivot point of the calf deck section and the thigh deck section when the user control mechanism is configured to pivot the calf deck section and the thigh deck section to create the articulated position,
wherein the mattress comprises a cushioning layer and at least one weight, the at least one weight located in or adjacent to the cushioning layer, wherein the at least one weight is configured to maintain substantially full contact between the mattress and the patient support deck when the calf deck section and the thigh deck section are in the articulated position.

2. The patient support apparatus of claim 1, wherein the at least one weight is at least about 2 lbs to about 25 lbs.

3. The patient support apparatus of claim 1, wherein the at least one weight comprises at least one of sand, metal, plastic, rubber, and gel.

4. The patient support apparatus of claim 1, wherein the cushioning layer comprises an upper cushioning layer and a lower cushioning layer and the at least one weight is located between the upper cushioning layer and the lower cushioning layer.

5. The patient support apparatus of claim 1, wherein the cushioning layer comprises foam.

6. The patient support apparatus of claim 1, wherein the mattress comprises a plurality of weights.

7. The patient support apparatus of claim 1, wherein the at least one weight is positioned at a foot end of the mattress.

8. The patient support apparatus of claim 1, wherein the at least one weight comprises a plurality of layers.

9. The patient support apparatus of claim 8, wherein each of the plurality of layers comprises a different material.

10. The patient support apparatus of claim 1, wherein the at least one weight comprises a radiolucent material.

11. The patient support apparatus of claim 1, wherein the calf deck section and the thigh deck section are at an angle of about 20 degrees to about 60 degrees relative to each other when the patient support deck is in the articulated position.

12. A mattress, comprising:
a cushioning layer including an upper cushioning layer and a lower cushioning layer; and
at least one weight positioned at a foot end of the mattress between the upper cushioning layer and the lower cushioning layer;
wherein the at least one weight is configured to maintain substantially full contact between the mattress and a support deck of a patient support apparatus when the support deck is in an articulated position, wherein the articulated position is defined by a first section of the support deck being pivotable relative to a second section of the support deck.

13. The mattress of claim 12, wherein the support deck is supported by an upper frame of the patient support apparatus.

14. The mattress of claim 12, wherein the first section and the second section are configured to be pivotable relative to one by a user control mechanism located on the patient support apparatus.

15. The mattress of claim 12, wherein the at least one weight is at least about 2 lbs to about 25 lbs.

16. The mattress of claim 12, wherein the at least one weight comprises at least one of sand, metal, plastic, rubber, and gel.

17. A method of operating a patient support apparatus, comprising:
pivoting a first section of a support deck relative to a second section of a patient support deck to define an articulated position; and
maintaining substantially full contact between a mattress positioned on the patient support deck and the patient support deck when the first section and the second section are in the articulated position,
wherein the mattress comprises a cushioning layer and at least one weight located in or adjacent to the cushioning layer.

18. The method of claim 17, wherein the support deck is supported by an upper frame of the patient support apparatus.

19. The method of claim 17, wherein the first section and the second section are configured to be pivotable relative to one by a user control mechanism located on the patient support apparatus.

20. The method of claim 17, wherein the first section and the second section are at an angle of about 20 degrees to about 60 degrees relative to each other when the support deck is in the articulated position.
